(19) United States
(12) Patent Application Publication
(10) Pub. No.: US 2025/0324203 A1
(43) Pub. Date: Oct. 16, 2025

(54) Speaker and Electronic Device

(71) Applicant: Huawei Technologies Co., Ltd., Shenzhen (CN)

(72) Inventors: Yubo Liu, Wuhan (CN); Jing Chang, Shanghai (CN); Zhenxing Xu, Dongguan (CN); Zheng Liu, Dongguan (CN)

(21) Appl. No.: 18/866,320

(22) PCT Filed: May 11, 2023
(86) PCT No.: PCT/CN2023/093580

§ 371 Date: Nov. 15, 2024

(30) Foreign Application Priority Data
May 16, 2022 (CN) 202221168704.6

(51) Int. Cl. H04R 9/02; H04R 1/02; H04R 7/04; H04R 9/06

(52) U.S. Cl. CPC H04R 9/025; H04R 1/028; H04R 7/04; H04R 9/06; H04R 2400/11

(57) ABSTRACT

A speaker includes a diaphragm assembly and a magnetic circuit assembly. The magnetic circuit assembly can provide a magnetic field to enable the diaphragm assembly to vibrate and emit a sound. The magnetic circuit assembly includes a first magnet and a second magnet. The diaphragm assembly includes a voice coil. The first magnet is disposed around the second magnet. The voice coil is disposed between the first magnet and the second magnet. The speaker includes a plurality of magnetic circuit assemblies. Two adjacent magnetic circuit assemblies share a same first magnet, and there is a gap between adjacent first magnets, to form a vent groove.

### TECHNICAL FIELD

This application relates to the field of acoustic device technologies, and in particular, to a speaker and an electronic device.

### BACKGROUND

A speaker can implement a sound emitting function, and is a common component on an electronic device. With development of technologies, various electronic devices, such as a tablet, a computer, and a television, develop towards lightness and thinness. Because an overall size of the electronic device is reduced, a requirement for lightness and thinness is also raised for various components in the electronic device. When a thickness is fixed, improvement of speaker effect mainly depends on increases in horizontal and vertical sizes. Currently, most speakers use a single magnetic circuit system design or a five magnetic circuit system design. The single magnetic circuit system design reduces a magnetic circuit conversion rate, and the five magnetic circuit system design causes poor air exhaust and high acoustic resistance. These affect sound effect of the speaker.

### SUMMARY

This application provides a speaker and an electronic device, to resolve a problem that the speaker has a low Q factor and poor air exhaust while improving efficiency.

This application provides a speaker, where the speaker includes:
a diaphragm assembly, where the diaphragm assembly includes a voice coil; and
a magnetic circuit assembly, where the magnetic circuit assembly includes a first magnet and a second magnet. the first magnet is disposed around the second magnet, and a vent groove is provided between adjacent first magnets; and
the voice coil is disposed between the second magnet and the first magnet, the speaker includes a plurality of magnetic circuit assemblies, two adjacent magnetic circuit assemblies share a same first magnet, and when the voice coil moves relative to the magnetic circuit assembly, the vent groove is configured to improve air exhaust efficiency.

After the voice coil is powered on, a current is generated in the voice coil, and therefore a magnetic field is generated. The voice coil moves under a force in the magnetic field generated by a central magnet and a side magnet. When the current in the voice coil changes, the magnetic field generated by the voice coil also changes. The change includes a change in magnetic field polarity caused by a change in current direction. Therefore, the voice coil vibrates back and forth, and the speaker emits a sound. A larger current that is input to the voice coil indicates a greater action force generated by the magnetic field of the energized voice coil, a greater amplitude of the vibration, and a louder sound. A connection manner of the voice coil may be defined based on an actual product size through simulation. For example, an electrical connection manner of the voice coil may be a parallel connection manner, a series connection manner, or a series-parallel connection manner.

The magnetic field assembly is designed with a five magnetic circuit system, and can provide a strong magnetic field. to improve a driving force of the speaker. Specific sizes of the side magnet and the central magnet may be set differently based on an actual requirement. Adjacent side magnets may be vertically disposed to form a rectangle. The central magnet is disposed in a center of the rectangle formed by the side magnets. A shape of the voice coil may be set to be a rectangle, and the voice coil is installed between the central magnet and the side magnets. The voice coil pushes air inside the magnetic circuit assembly in a vibration process. There is a gap between two adjacent side magnets to form the vent groove for air exhaust, and the rectangle enclosed by the side magnets includes four gaps, so that an overall area of the vent groove is increased, and air can be exhausted from a plurality of directions at the same time. This improves air exhaust efficiency, and therefore increases a Q factor of the speaker. In addition, the gaps are disposed at locations of four corners of the rectangle, so that impact on the magnetic field can be reduced, and the magnetic circuit assembly has a sufficient driving force.

The speaker is provided with the plurality of magnetic circuit assemblies, and the plurality of magnetic circuit assemblies are sequentially disposed in a length direction of the speaker, where two adjacent magnetic circuit assemblies may share one side magnet. This saves internal space and material costs of the speaker and improves a normalized material rate. In addition, when the plurality of magnetic circuit assemblies are disposed in the length direction of the speaker, the vent grooves between the side magnets are located on an outer side of the plurality of magnetic circuit assemblies, and the vent grooves have small mutual impact during air exhaust, so that the vent grooves can keep smooth air exhaust. The speaker provided in this application is mainly in a light, thin, and long form, and therefore is mainly used in product forms such as a tablet, a notebook computer, and a large-screen television.

Compared with an existing case in which because a plurality of magnetic circuit assemblies in a speaker are in a non-linear array, for example, the plurality of magnetic circuit assemblies are disposed in a plurality of rows and a single row is provided with a plurality of magnetic circuit assemblies, air exhaust of the magnetic circuit assemblies affects each other, especially at a corner location of adjacent magnetic circuit assemblies, affecting a Q factor of the speaker and heat dissipation of the speaker and causing the speaker to reach a temperature limit at low power, this application in which the plurality of magnetic circuit assemblies are arranged in a single linear row and the vent grooves can be located on the outer side of the entire magnetic circuit assemblies reduces mutual impact between the vent grooves during air exhaust, improves air exhaust efficiency; and increases the Q factor of the speaker.

In a possible implementation, the speaker includes a first washer and a second washer. the first washer is disposed on the second magnet. and the second washer is disposed on the first magnet.

The first washer may be a central washer, and the second washer may be a side washer. The side washer and the central washer are configured to connect to and fasten the side magnet and the central magnet, and can further achieve magnetic conduction effect. N poles and S poles of the central magnet and the side magnet are concentrated in the gap between the central magnet and the side magnet through a loop, so that a strong magnetic field exists in the gap, and the voice coil located in the gap can be affected by the strong magnetic field.

In a possible implementation, the speaker includes a basket component, the basket component is disposed at an edge of the speaker, the basket component is provided with an air exhaust groove, and the air exhaust groove is provided at an edge of an inner ring of the basket component in a length direction of the speaker.

The basket component is configured to fasten and install the magnetic circuit assembly and reduce magnetic force dispersion. The basket component is provided with the air exhaust groove. The air exhaust groove is disposed at the edge of the inner ring of the basket component in the length direction of the speaker, and the air exhaust groove is recessed in a direction away from the magnetic circuit assembly. The air exhaust groove is provided between two magnetic circuit assemblies, and may be specifically provided between two adjacent side magnets. In this way, magnetic force dispersion effect on the magnetic field is small, and the air exhaust groove can improve air exhaust efficiency, and increase the Q factor of the speaker. The basket component can support the voice coil, and a hole corresponding to the magnetic circuit assembly is provided on the basket component. When the voice coil moves in a thickness direction of the speaker, the basket component can reduce movement of the voice coil in the length direction and the width direction of the speaker, and reduce a possibility that the voice coil deviates and collides with the side washer and the central washer. The vent groove is further provided between the basket component and a yoke provided in this application, and an air exhaust gap is provided on two sides of the speaker in the length direction of the speaker, to further improve air exhaust efficiency.

In a possible implementation, the speaker is provided with four magnetic circuit assemblies, and the magnetic circuit assemblies are sequentially disposed in the length direction of the speaker.

The four magnetic circuit assemblies include thirteen side magnets and four central magnets in total. Two adjacent magnetic circuit assemblies share one side magnet, and correspondingly, four central washers and three side washers are disposed. The central washer and the central magnet are correspondingly disposed, and the side washer and the side magnet shared by the two adjacent magnetic circuit assemblies are correspondingly disposed. The speaker provided in this application is mainly disposed on a light and thin electronic device. Therefore, a thickness of the speaker is limited. The plurality of magnetic circuit assemblies are disposed to improve magnetic circuit conversion efficiency and provide more power, and therefore improve sound volume and sound quality in limited space.

In a possible implementation, the speaker includes a yoke, the yoke is configured to install the magnetic circuit assembly, the yoke includes a first yoke, a second yoke, and a third yoke, and the second yoke is disposed between the first yoke and the third yoke.

When the speaker includes a plurality of magnetic circuit assemblies, the plurality of magnetic circuit assemblies need to be positioned during installation. The plurality of magnetic circuit assemblies may be first installed on the first yoke, the second yoke, and the third yoke respectively. For example, when the speaker includes four magnetic circuit assemblies, the first yoke and the third yoke may each install and position one magnetic circuit assembly, the second yoke install and position two magnetic circuit assemblies, and then the first yoke, the second yoke, and the third yoke are connected to each other. Compared with an entire yoke on which four magnetic circuit assemblies are directly positioned and installed, the split-style yoke reduces a quantity of components of each part, and therefore reduces positioning difficulty of each part. This reduces overall difficulty of visual positioning and assembly, more accurately controls a magnetic gap, shortens a total magnetic gap tolerance chain, shortens an assembly period, and improves assembly precision and an assembly yield.

In a possible implementation, the first yoke, the second yoke, and the third yoke are provided with a connecting part, a side that is of each of the first yoke and the third yoke and that is close to the second yoke is provided with a connecting part, and two sides of the second yoke are provided with connecting parts.

During assembly of the speaker, the magnetic circuit assemblies may be first installed on the first yoke, the second yoke, and the third yoke respectively, and are connected to each other through the connecting part for assembly, and then a diaphragm is installed. The diaphragm may be installed by using an auxiliary steel ring. During installation, the diaphragm needs to at least partially cover a side wall of the basket component, and a recess part is disposed on the side wall of the basket component, so that the side wall is flat after the basket component is covered by the diaphragm. The auxiliary steel ring may be disposed at an edge of the basket component, and a height of the auxiliary steel ring may be the same as a height of the recess part of the side wall of the basket component. Because a recess depth of the recess part is small, positioning and installation are not convenient. When the diaphragm is positioned and installed, the auxiliary steel ring can position and support the diaphragm, to facilitate installation of the diaphragm. After the diaphragm is installed, the auxiliary steel ring is removed. A flexible printed circuit may be further disposed between the diaphragm and the basket component, to form a cantilever beam for supporting.

In a possible implementation, the connecting part is disposed in a wedge shape, the connecting part is of a step structure, and the connecting parts are capable of positioning and connecting to each other.

The connecting part may be disposed as a boss, so that the plurality of connecting parts can overlap each other This facilitates that the first yoke and the third yoke are first positioned Afterward the second yoke between the first yoke and the third yoke is installed, and finally connection is performed in a manner such as glue dispensing or laser welding. During installation, the first yoke and the third yoke may be positioned to a preset location, and positioned and installed with the diaphragm; and then the second yoke, the first yoke, and the third yoke are positioned at the same time, and the connecting part of the second yoke is connected to the connecting part of each of the first yoke and the third yoke, to complete assembly of the speaker

The connecting part may alternatively be disposed as fitting between a protrusion part and a groove. For example, a protrusion part is disposed on a side wall of each of the first yoke and the third yoke, a groove is disposed on a side wall of the third yoke, and at least a part of the protrusion part can extend into the groove. This design facilitates accurate positioning between the parts, and connection is performed in a manner of dispensing or welding. In this way, the first yoke, the second yoke, and the third yoke are connected. The separated magnetic circuit is a special structural design for improving process concentricity control, that is, improving positioning accuracy. The plurality of magnetic circuit assemblies include a large quantity of magnetic gaps. The separated magnetic circuit design provided in embodiments of this application can improve positioning accuracy. This implements an assembly yield in a scenario with an excessively large quantity of magnetic gaps, and therefore improves feasibility of the solution.

In a possible implementation, the yoke is provided with an avoidance part, and the avoidance part is configured to install a conductive member.

The speaker needs to be electrically connected by using the conductive member. The avoidance part may be provided at a corner location of the yoke, and the conductive member may be disposed at a location of the avoidance part. A quantity and a location of the avoidance part may be set based on an actual situation of the conductive member. The conductive member may be disposed based on a connection manner such as a serial connection and a parallel connection of the voice coil. The avoidance part is configured to reserve a location for installing the conductive member on the yoke, and the conductive member may not protrude from a surface of the speaker, so that the surface of the speaker is flat. The conductive member includes a positive conductive pad and a negative conductive pad that perform a conduction function.

In a possible implementation, the diaphragm assembly includes a diaphragm and a ball dome, the diaphragm covers the magnetic circuit assembly, and the ball dome is disposed between the diaphragm and the magnetic circuit assembly.

The diaphragm is a sound radiation component of the speaker and has great impact on sound emitting performance of the speaker. The diaphragm needs to rapidly respond to a rapidly changing signal and bear an air pressure generated during high-speed movement. Therefore, the diaphragm needs to be light and has sufficient strength. In addition, the diaphragm should not deform greatly under changes in ambient temperature and humidity. Otherwise, sound emitting effect of the speaker may be affected. The diaphragm may usually be made of plastic, metal, or composite materials, and a shape and a structure of the diaphragm may be set based on a quantity and a location of the magnetic circuit assembly. The diaphragm is soft, and the hard ball dome is disposed between the magnetic circuit assembly and the diaphragm, to support the diaphragm.

This application provides an electronic device, where the electronic device includes a speaker, and the speaker is the speaker according to any one of claims.

Embodiments of this application provide a speaker and an electronic device. The speaker includes a diaphragm assembly and a magnetic circuit assembly. The magnetic circuit assembly can provide a magnetic field to enable the diaphragm assembly to vibrate and emit a sound. The magnetic circuit assembly includes a first magnet and a second magnet. The diaphragm assembly includes a voice coil. The first magnet is disposed around the second magnet. The voice coil is disposed between the first magnet and the second magnet. There is a gap between adjacent first magnets, to form a vent groove. The vent groove can exhaust air when the voice coil vibrates. The magnetic circuit assembly includes a plurality of vent grooves and can exhaust air from different directions at the same time. This improves air exhaust efficiency and therefore improves sound quality of the speaker.

It should be understood that the foregoing general descriptions and the following detailed descriptions are merely examples, and cannot limit this application.

### BRIEF DESCRIPTION OF DRAWINGS

FIG. 1 is an exploded view of a speaker according to this application;

FIG. 2 is a diagram of assembly of a magnetic circuit assembly, a side washer, and a central washer according to this application;

FIG. 3 is a diagram of a basket component according to this application;

FIG. 4 is a diagram of assembly of a magnetic circuit assembly and a yoke according to this application;

FIG. 5 is a diagram of assembly of a basket component and a magnetic circuit assembly according to this application;

FIG. 6 is a diagram of assembly of a diaphragm and a ball dome according to this application;

FIG. 7 is a sectional view of a speaker according to this application;

FIG. 8 is a diagram of a structure of a speaker from another perspective according to this application;

FIG. 9 is a diagram of assembly of a yoke according to this application;

FIG. 10 is a diagram of assembly of a yoke from another perspective according to this application;

FIG. 11 is a sectional view of assembly of a yoke according to this application;

FIG. 12 is a partial enlarged diagram of I in FIG. 11;

FIG. 13 is a diagram of a structure of a yoke and a magnetic circuit assembly from another perspective according to this application;

FIG. 14 is a diagram of assembly of an auxiliary steel ring according to this application;

FIG. 15 is an exploded view of a speaker from another perspective according to this application;

FIG. 16 is a diagram of assembly of a first yoke, a second yoke, and a third yoke according to this application;

FIG. 17 is a diagram of a structure of an electronic device according to this application; and

FIG. 18 is a sectional view of an electronic device according to this application.

### REFERENCE NUMERALS

1: magnetic circuit assembly; 11: central magnet; 12: side magnet; 13: vent groove; 2: diaphragm assembly; 21: voice coil; 22: diaphragm; 23: ball dome; 3: first washer; 4: second washer; 5: basket component; 51: air exhaust groove; 6: yoke; 61: first yoke; 62: second yoke; 63: third yoke; 64: connecting part; 65: avoidance part; 7: conductive member; 8: auxiliary steel ring; 9: flexible printed circuit; A: speaker; B: electronic device.

The accompanying drawings herein are incorporated into this specification and constitute a part of this specification, show embodiments conforming to this application, and are used together with this specification to explain a principle of this application

### DESCRIPTION OF EMBODIMENTS

For ease of understanding technical solutions of this application, the following describes embodiments of this application in detail with reference to accompanying drawings.

It should be noted that the described embodiments are merely some but not all of embodiments of this application. All other embodiments obtained by a person of ordinary skill in the art based on embodiments of this application without creative efforts shall fall within the protection scope of this application.

Terms used in embodiments of this application are merely for the purpose of describing specific embodiments, but are not intended to limit this application. The terms “a”, “said” and “the” of singular forms used in embodiments and the appended claims of this application are also intended to include plural forms, unless otherwise specified in the context clearly.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be noted that orientation words such as “above”, “below”, “left”, and “right” described in embodiments of this application are described from perspectives shown in the accompanying drawings, and should not be construed as a limitation on embodiments of this application. Moreover, in the context, it also should be understood that when it is mentioned that one element is connected “above” or “below” another element, the element can be directly connected “above” or “below” the another element, or may be indirectly connected “above” or “below” the another element by using an intermediate element.

Current electronic products develop towards lightness and thinness, and therefore various electronic components in electronic products also need to be light and thin. A speaker is a common electronic component in electronic products. When a thickness of the speaker is limited, performance improvement of the speaker mainly relies on an increase in an effective radiation area (Sd) of a diaphragm 22. A current speaker usually uses a single magnetic circuit system (single magnetic circuit system) design or a five magnetic circuit system (five magnetic circuit system) design. When the diaphragm 22 has a specific effective radiation area, a single magnetic circuit system design causes low magnetic circuit conversion efficiency (BL), and a multi-magnetic circuit system design causes poor air exhaust of a posterior cavity (Posterior cavity deflated) and high acoustic resistance, and therefore affects a mechanical quality factor (Q factor, Qms) and sensitivity.

Based on this, an embodiment of this application provides a speaker A, to resolve a problem that the speaker A has a low Q factor and poor air exhaust while improving efficiency.

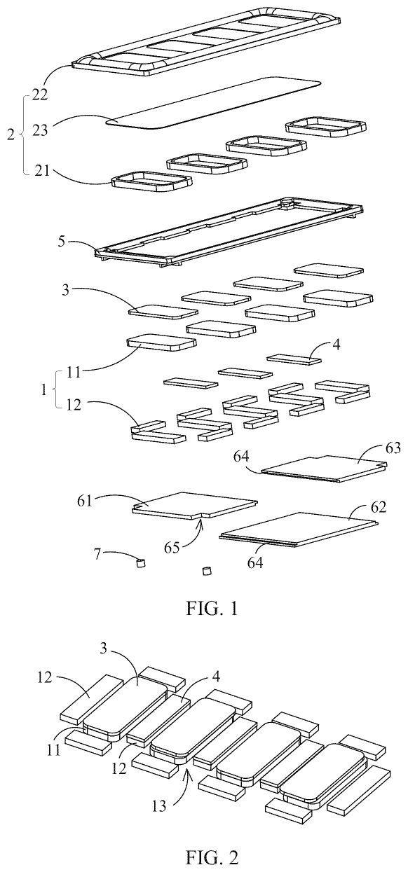

As shown in FIG. 1 and FIG. 2, an embodiment of this application provides a speaker A. The speaker A includes a diaphragm assembly 2 and a magnetic circuit assembly 1. The diaphragm assembly 2 is connected to the magnetic circuit assembly 1. The magnetic circuit assembly 1 can provide a magnetic field, and the diaphragm assembly 2 can vibrate and emit a sound in the magnetic field. The magnetic circuit assembly 1 includes a first magnet and a second magnet. The first magnet may be a central magnet 11, and the second magnet may be a side magnet 12. The side magnet 12 is disposed around the central magnet 11, the diaphragm assembly 2 includes a voice coil 21, and the voice coil 21 is disposed between the central magnet 11 and the side magnet 12. After the voice coil 21 is powered on, a current is generated in the voice coil 21, and therefore a magnetic field is generated. The voice coil 21 moves under a force in the magnetic field generated by the central magnet 11 and the side magnet 12. When the current in the voice coil 21 changes, the magnetic field generated by the voice coil 21 also changes. The change includes a change in magnetic field polarity caused by a change in current direction. Therefore, the voice coil 21 vibrates back and forth, and the speaker A emits a sound. A larger current that is input to the voice coil 21 indicates a greater action force generated by the magnetic field of the energized voice coil, a greater amplitude of the vibration, and a louder sound. A connection manner of the voice coil 21 may be defined based on an actual product size through simulation. For example, an electrical connection manner of the voice coil 21 may be a parallel connection manner, a series connection manner, or a series-parallel connection manner.

The magnetic field assembly is designed with a five magnetic circuit system, and can provide a strong magnetic field, to improve a driving force of the speaker A. Specific sizes of the side magnet 12 and the central magnet 11 may be set differently based on an actual requirement. Adjacent side magnets 12 may be vertically disposed to form a rectangle. The central magnet 11 is disposed in a center of the rectangle formed by the side magnets 12. A shape of the voice coil 21 may be set to be a rectangle, and the voice coil 21 is installed between the central magnet 11 and the side magnets 12. The voice coil 21 pushes air inside the magnetic circuit assembly 1 in a vibration process. There is a gap between two adjacent side magnets 12 to form a vent groove 13 for air exhaust, and the rectangle enclosed by the side magnets 12 includes four gaps, so that an overall area of the vent groove 13 is increased. and air can be exhausted from a plurality of directions at the same time. This improves air exhaust efficiency, and therefore increases a Q factor of the speaker A. In addition, the gaps are disposed at locations of four corners of the rectangle, so that impact on the magnetic field can be reduced, and the magnetic circuit assembly 1 has a sufficient driving force.

The speaker A is provided with a plurality of magnetic circuit assemblies 1. and the plurality of magnetic circuit assemblies 1 are sequentially disposed in a length direction X of the speaker A, where two adjacent magnetic circuit assemblies 1 may share one side magnet 12. This saves internal space and material costs of the speaker A and improves a normalized material rate. In addition, when the plurality of magnetic circuit assemblies 1 are disposed in the length direction X of the speaker A, the vent grooves 13 between the side magnets 12 are located on an outer side of the plurality of magnetic circuit assemblies 1, and the vent grooves 13 have small mutual impact during air exhaust, so that the vent grooves 13 can keep smooth air exhaust. The speaker A provided in this application is mainly in a light, thin, and long form, and therefore is mainly used in product forms such as a tablet, a notebook computer, and a large-screen television.

Compared with an existing case in which because a plurality of magnetic circuit assemblies 1 in a speaker A are in a non-linear array, for example, the plurality of magnetic circuit assemblies 1 are disposed in a plurality of rows and a single row is provided with a plurality of magnetic circuit assemblies 1, air exhaust of the magnetic circuit assemblies 1 affects each other, especially at a corner location of adjacent magnetic circuit assemblies 1, affecting a Q factor of the speaker A and heat dissipation of the speaker A and causing the speaker A to reach a temperature limit at low power, this application in which the plurality of magnetic circuit assemblies 1 are arranged in a single linear row and the vent grooves 13 can be located on the outer side of the entire magnetic circuit assemblies 1 reduces mutual impact between the vent grooves 13 during air exhaust, improves air exhaust efficiency, and increases the Q factor of the speaker A.

As shown in FIG. 2, in a possible implementation, the speaker A further includes a first washer 3 and a second washer 4. The first washer 3 may be a central washer, and the second washer 4 may be a side washer. The central washer is correspondingly installed on the central magnet 11, and the side washer is disposed between two magnetic circuit assemblies 1, that is, installed on the side magnet 12 shared by two adjacent magnetic circuit assemblies 1.

The side washer and the central washer are configured to connect to and fasten the side magnet 12 and the central magnet 11, and can further achieve magnetic conduction effect. N poles and S poles of the central magnet 11 and the side magnet 12 are concentrated in the gap between the central magnet 11 and the side magnet 12 through a loop, so that a strong magnetic field exists in the gap, and the voice coil 21 located in the gap can be affected by the strong magnetic field.

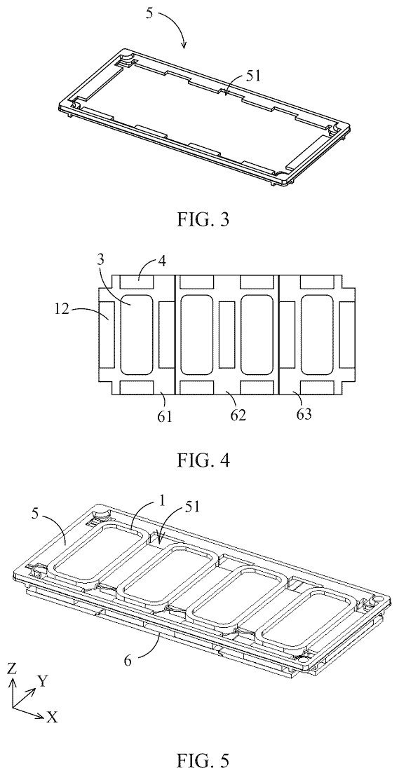

As shown in FIG. 3 to FIG. 5, in a possible implementation, the speaker A further includes a basket component 5 that is disposed around an edge of the speaker A and that is configured to fasten and install the magnetic circuit assembly 1 and reduce magnetic force dispersion. The basket component 5 is provided with an air exhaust groove 51. The air exhaust groove 51 is disposed at an edge of an inner ring of the basket component 5 in the length direction X of the speaker A, and the air exhaust groove 51 is recessed in a direction away from the magnetic circuit assembly 1. The air exhaust groove 5 | is provided between two magnetic circuit assemblies 1, and may be specifically provided between two adjacent side magnets 12. In this way, magnetic force dispersion effect on the magnetic field is small, and the air exhaust groove 51 can improve air exhaust efficiency, and increase the Q factor of the speaker A. The basket component 5 can support the voice coil, and a hole corresponding to the magnetic circuit assembly 1 is provided on the basket component 5. When the voice coil 21 moves in a thickness direction of the speaker A, the basket component 5 can reduce movement of the voice coil 21 in the length direction and the width direction of the speaker A, and reduce a possibility that the voice coil 21 deviates and collides with the side washer and the central washer. The vent groove 13 is further provided between the basket component 5 and a yoke (Yoke) 6 provided in this application, and an air exhaust gap is provided on two sides of the speaker A in the length direction X of the speaker A, to further improve air exhaust efficiency.

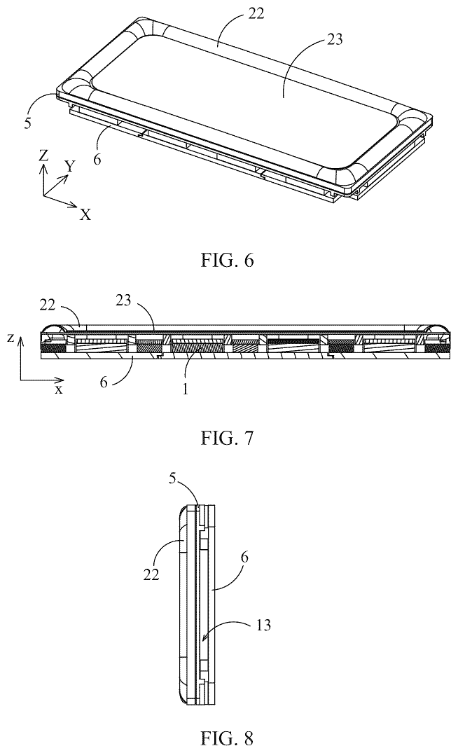

As shown in FIG. 6 and FIG. 7. in a possible implementation. the diaphragm assembly 2 further includes a diaphragm 22 and a ball dome 23. The diaphragm 22 covers the magnetic circuit assembly 1. When the voice coil 21 is powered on and vibrates, the diaphragm 22 can be driven to vibrate and therefore emit a sound.

The diaphragm 22 is a sound radiation component of the speaker A and has great impact on sound emitting performance of the speaker A. The diaphragm 22 needs to rapidly respond to a rapidly changing signal and bear an air pressure generated during high-speed movement. Therefore, the diaphragm 22 needs to be light and has sufficient strength. In addition, the diaphragm 22 should not deform greatly under changes in ambient temperature and humidity. Otherwise, sound emitting effect of the speaker A may be affected. The diaphragm 22 may usually be made of plastic, metal, or composite materials, and a shape and a structure of the diaphragm 22 may be set based on a quantity and a location of the magnetic circuit assembly 1. The diaphragm 22 is soft, and the hard ball dome 23 is disposed between the magnetic circuit assembly 1 and the diaphragm 22, to support the diaphragm 22.

As shown in FIG. 2, in a possible implementation, the speaker A includes at least two magnetic circuit assemblies 1. Specifically, the speaker A may include four magnetic circuit assemblies 1. The magnetic circuit assemblies 1 are sequentially disposed in the length direction X of the speaker A. The four magnetic circuit assemblies 1 include thirteen side magnets 12 and four central magnets 11 in total. Two adjacent magnetic circuit assemblies 1 share one side magnet 12, and correspondingly, four central washers and three side washers are disposed. The central washer and the central magnet 11 are correspondingly disposed, and the side washer and the side magnet 12 shared by the two adjacent magnetic circuit assemblies 1 are correspondingly disposed.

The speaker A provided in this application is mainly disposed on a light and thin electronic device B. Therefore, a thickness of the speaker A is limited. The plurality of magnetic circuit assemblies 1 are disposed to improve magnetic circuit conversion efficiency and provide more power, and therefore improve sound volume and sound quality in limited space.

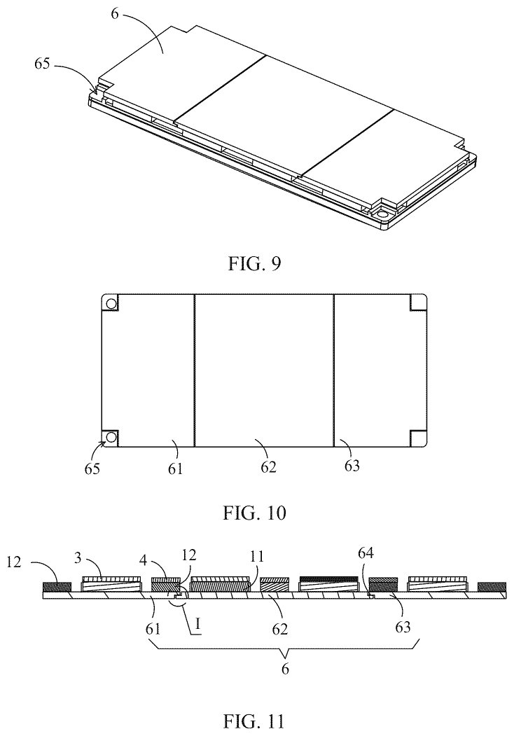

As shown in FIG. 9 and FIG. 10, in a possible implementation, the speaker A includes a yoke 6, the yoke 6 includes a first yoke 61, a second yoke 62, and a third yoke 63, and the second yoke 62 is disposed between the first yoke 61 and the third yoke 63.

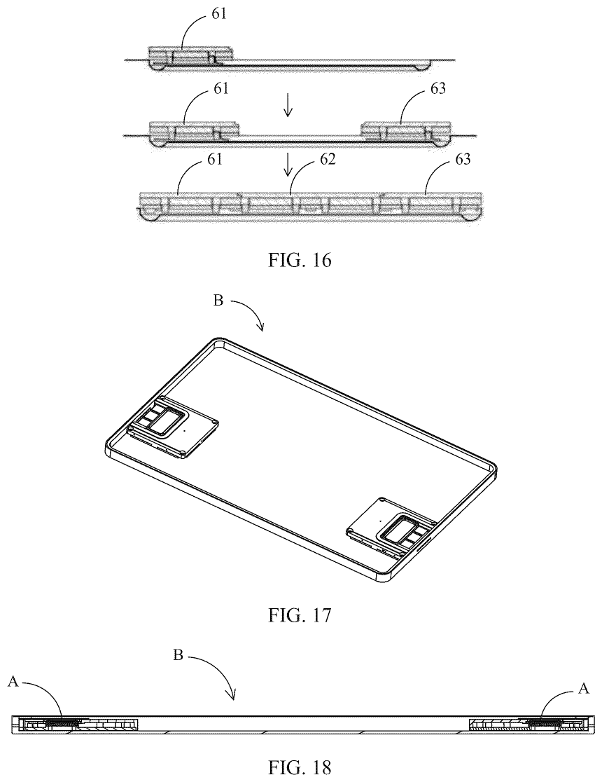

As shown in FIG. 16, when the speaker A includes a plurality of magnetic circuit assemblies 1, the plurality of magnetic circuit assemblies 1 need to be positioned during installation. The plurality of magnetic circuit assemblies 1 may be first installed on the first yoke 61, the second yoke 62, and the third yoke 63 respectively. For example, when the speaker A includes four magnetic circuit assemblies 1, the first yoke 61 and the third yoke 63 may each install and position one magnetic circuit assembly 1, the second yoke 62 install and position two magnetic circuit assemblies 1, and then the first yoke 61. the second yoke 62, and the third yoke 63 are connected to each other. Compared with an entire yoke 6 on which four magnetic circuit assemblies 1 are directly positioned and installed, the split-style yoke 6 reduces a quantity of components of each part, and therefore reduces positioning difficulty of each part. This reduces overall difficulty of visual positioning and assembly, more accurately controls a magnetic gap, shortens a total magnetic gap tolerance chain, shortens an assembly period, and improves assembly precision and an assembly yield.

As shown in FIG. 11 and FIG. 13, in a possible implementation, the first yoke 61, the second yoke 62, and the third yoke 63 are provided with a connecting part 64, a side that is of each of the first yoke 61 and the third yoke 63 and that is close to the second yoke 62 is provided with a connecting part 64, and a side that is of the second yoke 62 and that is close to each of the first yoke 61 and the third yoke 63 is provided with a connecting part 64, and the first yoke 61, the second yoke 62, and the third yoke 63 can be connected by using the connecting parts 64.

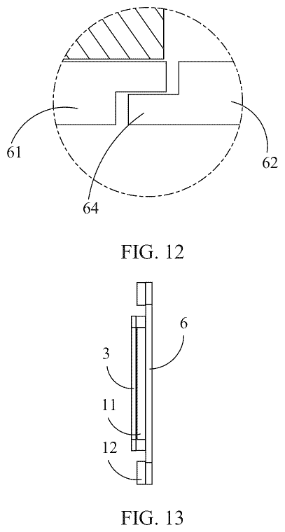

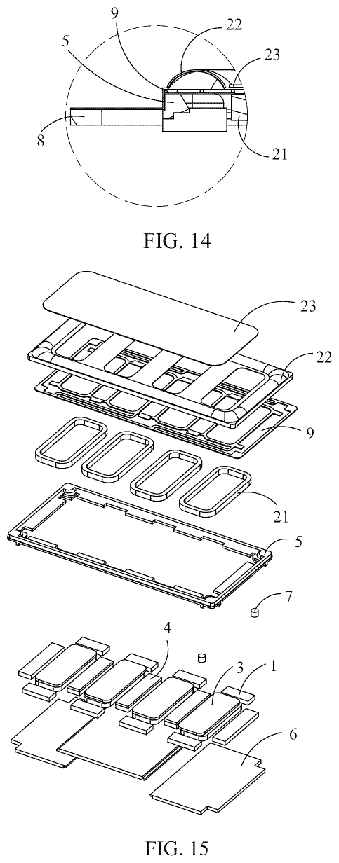

As shown in FIG. 12, in a possible implementation, the connecting part 64 is of a wedge-shaped structure, and the connecting parts 64 are capable of fitting and connecting to each other.

The connecting part 64 may be disposed as a boss, so that the plurality of connecting parts 64 can overlap each other. This facilitates that the first yoke 61 and the third yoke 63 are first positioned. Afterward the second yoke 62 between the first yoke 61 and the third yoke 63 is installed, and finally connection is performed in a manner such as glue dispensing or laser welding. During installation, the first yoke 61 and the third yoke 63 may be positioned to a preset location, and positioned and installed with the diaphragm 22; and then the second yoke 62, the first yoke 61, and the third yoke 63 are positioned at the same time, and the connecting part 64 of the second yoke 62 is connected to the connecting part 64 of each of the first yoke 61 and the third yoke 63, to complete assembly of the speaker A.

The connecting part 64 may alternatively be disposed as fitting between a protrusion part and a groove. For example, a protrusion part is disposed on a side wall of each of the first yoke 61 and the third yoke 63, a groove is disposed on a side wall of the third yoke 63, and at least a part of the protrusion part can extend into the groove. This design facilitates accurate positioning between the parts, and connection is performed in a manner of dispensing or welding. In this way, the first yoke 61, the second yoke 62, and the third yoke 63 are connected. The separated magnetic circuit is a special structural design for improving process concentricity control, that is, improving positioning accuracy. The plurality of magnetic circuit assemblies 1 include a large quantity of magnetic gaps. The separated magnetic circuit design provided in embodiments of this application can improve positioning accuracy. This implements an assembly yield in a scenario with an excessively large quantity of magnetic gaps, and therefore improves feasibility of the solution.

As shown in FIG. 15 and FIG. 16, during assembly of the speaker A. the magnetic circuit assemblies 1 may be first installed on the first yoke 61, the second yoke 62, and the third yoke 63 respectively, and are connected to each other through the connecting part 64 for assembly, and then the diaphragm 22 is installed. The diaphragm 22 may be installed by using an auxiliary steel ring. During installation, the diaphragm 22 needs to at least partially cover a side wall of the basket component 5, and a recess part is disposed on the side wall of the basket component 5, so that the side wall is flat after the basket component 5 is covered by the diaphragm 22. The auxiliary steel ring may be disposed at an edge of the basket component 5, and a height of the auxiliary steel ring may be the same as a height of the recess part of the side wall of the basket component 5. Because a recess depth of the recess part is small, positioning and installation are not convenient. When the diaphragm 22 is positioned and installed, the auxiliary steel ring can position and support the diaphragm 22, to facilitate installation of the diaphragm 22. After the diaphragm 22 is installed, the auxiliary steel ring is removed. A flexible printed circuit (FPC, Flexible Printed Circuit) may be further disposed between the diaphragm 22 and the basket component 5, to form a cantilever beam for supporting

As shown in FIG. 9 and FIG. 10, in a possible implementation, the yoke 6 is provided with an avoidance part 65, and the avoidance part 65 is provided at a corner location of the yoke 6 and is configured to avoid a conductive member 7.

The speaker A needs to be electrically connected by using the conductive member 7. The conductive member 7 may be disposed at a location of the avoidance part 65. A quantity and a location of the avoidance part 65 may be set based on an actual situation of the conductive member 7. The conductive member 7 may be disposed based on a connection manner such as a serial connection and a parallel connection of the voice coil 21. The avoidance part 65 is configured to reserve a location for installing the conductive member 7 on the yoke 6, and the conductive member 7 may not protrude from a surface of the speaker A, so that the surface of the speaker A is flat. The conductive member 7 includes a positive conductive pad and a negative conductive pad that perform a conduction function.

As shown in FIG. 17, an embodiment of this application further provides an electronic device B. The electronic device B includes a speaker A, and the speaker A is the speaker A in any one of the foregoing embodiments.

The speaker A is small in thickness and volume, has high air exhaust efficiency, and has high magnetic flux utilization and a great driving force. Therefore, the speaker A is disposed as a sound emitting device in the electronic device B, so that the electronic device B can have good sound quality in a narrow and long form of the electronic device B. This adapts to more use scenarios.

Embodiments of this application provide a speaker A and an electronic device B. The speaker A includes a diaphragm assembly 2 and a magnetic circuit assembly 1. The magnetic circuit assembly 1 can provide a magnetic field to enable the diaphragm assembly 2 to vibrate and emit a sound. The magnetic circuit assembly 1 includes a central magnet 11 and a side magnet 12. The diaphragm assembly 2 includes a voice coil 21. The side magnet 12 is disposed around the central magnet 11. The voice coil 21 is disposed between the side magnet 12 and the central magnet 11. There is a gap between adjacent side magnets 12, to form a vent groove 13. The vent groove 13 can exhaust air when the voice coil 21 vibrates. The magnetic circuit assembly 1 includes a plurality of vent grooves 13 and can exhaust air from different directions at the same time. This improves air exhaust efficiency and therefore improves sound quality of the speaker A.

The foregoing descriptions are merely examples of embodiments of this application, and are not intended to limit this application. For a person skilled in the art, this application may have various modifications and variations. Any modification, equivalent replacement, or improvement made without departing from the spirit and principle of this application shall fall within the protection scope of this application

1.-10. (canceled)

11. A speaker comprising:
magnetic circuit assemblies comprising:
a first magnetic circuit assembly comprising:
a first magnet; and
a second magnet; and
a second magnetic circuit assembly sequentially disposed with the first magnetic circuit assembly in a length direction of the speaker, wherein the second magnetic circuit assembly comprises:
a third magnet; and
the first magnet such that the first magnet is disposed between the second magnet and the third magnet; and
a vent groove positioned between the first magnetic circuit assembly and the second magnetic circuit assembly;
a yoke component;
a basket component disposed in a circumferential direction of the speaker such that the vent groove is disposed between the yoke component and the basket component, wherein the basket component comprises:
an inner ring comprising an edge; and
an air exhaust groove disposed at the edge and in the length direction between the first magnetic circuit assembly and the second magnetic circuit assembly; and
a voice coil disposed between the second magnet and the first magnet and configured to move relative to the magnetic circuit assemblies.

12. The speaker of claim 11, further comprising:
a first washer disposed on the second magnet; and
a second washer disposed on the first magnet.

13. The speaker of claim 12, further comprising a third washer disposed on the third magnet.

14. The speaker of claim 11, wherein the magnetic circuit assemblies are configured to be installed on the yoke component, and the yoke component comprises:
a first yoke;
a second yoke; and
a third yoke, wherein the second yoke is disposed between the first yoke and the third yoke.

15. The speaker of claim 14, wherein the second yoke comprises two connecting parts, wherein the first yoke comprises a first connecting part positioned adjacent to one of the two connecting parts, and wherein the third yoke comprises a third connecting part positioned adjacent to another one of the two connecting parts.

16. The speaker of claim 15, wherein the connecting parts have a step-shaped structure and are configured to connect to each other.

17. The speaker of claim 15, wherein the yoke component comprises an avoidance part, wherein the speaker further comprises a conductive member configured to be installed on the yoke component at a location of the avoidance part, and wherein the avoidance part is configured to avoid the conductive member at the location.

18. The speaker of claim 11, further comprising a diaphragm assembly, wherein the diaphragm assembly comprises:
the voice coil;
a diaphragm configured to cover the magnetic circuit assemblies and emit sound upon vibration of the voice coil; and
a ball dome disposed between the diaphragm and the magnetic circuit assemblies.

19. An electronic device comprising:
a speaker comprising:
magnetic circuit assemblies comprising:
an outer side;
a first magnetic circuit assembly comprising:
a first magnet; and
a second magnet; and
a second magnetic circuit assembly sequentially disposed with the first magnetic circuit assembly in a length direction of the speaker, wherein the second magnetic circuit assembly comprises:
a third magnet; and
the first magnet such that the first magnet is disposed between the second magnet and the third magnet; and
a vent groove positioned between the first magnetic circuit assembly and the second magnetic circuit assembly on the outer side;
a yoke component;
a basket component disposed in a circumferential direction of the speaker such that the vent groove is disposed between the yoke component and the basket component, wherein the basket component comprises:
an inner ring comprising an edge; and
an air exhaust groove disposed at the edge and in the length direction between the first magnetic circuit assembly and the second magnetic circuit assembly; and
a voice coil disposed between the second magnet and the first magnet and configured to move relative to the magnetic circuit assemblies.

20. The electronic device of claim 19, further comprising:
a first washer disposed on the second magnet; and
a second washer disposed on the first magnet.

21. The electronic device of claim 20, further comprising a third washer disposed on the third magnet.

22. The electronic device of claim 19, wherein the magnetic circuit assemblies are configured to be installed on the yoke component, and the yoke component comprises:
a first yoke;
a second yoke; and
a third yoke, wherein the second yoke is disposed between the first yoke and the third yoke.

23. The electronic device of claim 22, wherein the second yoke comprises two connecting parts, wherein the first yoke comprises a first connecting part positioned adjacent to one of the two connecting parts, and wherein the third yoke comprises a third connecting part positioned adjacent to another one of the two connecting parts.

24. The electronic device of claim 23, wherein the connecting parts have a step-shaped structure, and are configured to connect to each other.

25. The electronic device of claim 23, wherein the yoke component comprises an avoidance part, wherein the speaker further comprises a conductive member configured to be installed on the yoke component at a location of the avoidance part, and wherein the avoidance part is configured to avoid the conductive member at the location.

26. The electronic device of claim 19, further comprising a diaphragm assembly, wherein the diaphragm assembly comprises:
the voice coil;
a diaphragm configured to cover the magnetic circuit assemblies and emit sound upon vibration of the voice coil; and
a ball dome disposed between the diaphragm and the magnetic circuit assemblies.

27. A speaker comprising:
magnetic circuit assemblies comprising:
a first magnetic circuit assembly comprising:
a first magnet; and
a second magnet; and
a second magnetic circuit assembly sequentially disposed with the first magnetic circuit assembly in a length direction of the speaker, wherein the second magnetic circuit assembly comprises:
a third magnet; and
the first magnet such that the first magnet is disposed between the second magnet and the third magnet;
a vent groove positioned between the first magnetic circuit assembly and the second magnetic circuit assembly;
a yoke component comprising:
a first yoke;
a second yoke; and
a third yoke, wherein the second yoke is disposed between the first yoke and the third yoke, and wherein the first magnetic circuit assembly and the second magnetic circuit assembly are disposed on the second yoke;
a basket component disposed in a circumferential direction of the speaker such that the vent groove is disposed between the yoke component and the basket component, wherein the basket component comprises:
an inner ring comprising an edge; and
an air exhaust groove disposed at the edge and in the length direction between the first magnetic circuit assembly and the second magnetic circuit assembly; and
a voice coil disposed between the second magnet and the first magnet and configured to move relative to the magnetic circuit assemblies.

28. The speaker of claim 27, further comprising:
a third magnetic circuit assembly comprising:
a fourth magnet; and
a fifth magnet, wherein the third magnetic circuit assembly is disposed on the first yoke; and
a fourth magnetic circuit assembly comprising:
a sixth magnet; and
a seventh magnet, wherein the fourth magnetic circuit assembly is disposed on the third yoke.

29. The speaker of claim 28, wherein the fourth magnet is disposed between second magnet and the fifth magnet, and wherein the sixth magnet is disposed between the third magnet and the seventh magnet.

30. The speaker of claim 27, wherein the second yoke comprises two connecting parts, wherein the first yoke comprises a first connecting part positioned adjacent to one of the two connecting parts, and wherein the third yoke comprises a third connecting part positioned adjacent to another one of the two connecting parts.
